(19) United States
(12) Patent Application Publication
(10) Pub. No.: US 2024/0134952 A1
(43) Pub. Date: Apr. 25, 2024

(54) INFORMATION PROCESSING APPARATUS AND CONTROL METHOD

(71) Applicant: Lenovo (Singapore) Pte. Ltd., Singapore (SG)

(72) Inventor: Dadao Tian, Kanagawa (JP)

(73) Assignee: Lenovo (Singapore) Pte. Ltd., Singapore (SG)

(21) Appl. No.: 18/459,417

(22) Filed: Aug. 31, 2023

(30) Foreign Application Priority Data
Oct. 20, 2022 (JP) 2022-168998

(51) Int. Cl. G06F 21/32

(52) U.S. Cl. CPC G06F 21/32

(57) ABSTRACT

The information processing apparatus includes: a chassis variable in form; a system device; a sensor for acquiring biological information; a user authentication unit which changes the operating mode of the system device from a power-saving mode to a standard mode consumed more power when a user to be registered is identified using the biological information as a pre-registered user; and a power supply circuit, wherein the sensor is placed in the chassis, and the power supply circuit controls the supply of power to the user authentication unit based on the form.

### CROSS-REFERENCE TO RELATED APPLICATIONS

This application claims priority to Japanese Patent Application No. 2022-168998 filed on Oct. 21, 2022, the contents of which are hereby incorporated herein by reference in their entirety.

### BACKGROUND

### Technical Field

The present invention relates to an information processing apparatus and a control method, for example, for output control of a user authentication module.

### Description of Related Art

There is an information processing apparatus such as a PC (Personal Computer) or a smartphone including a user authentication module to ensure security. There is a user authentication module to put the information processing apparatus into operation when acquiring biological information and determining that the acquired biological information is biological information on a pre-registered user. As the biological information, for example, a user's fingerprint is used. An individual user is identified by the personality of biological information after presenting the biological information (for example, pressing a start button by fingertip contact) to detect the intention of use by the user. Therefore, the security of the information processing apparatus is ensured without impairing convenience.

For example, an image processing device described in Japanese Unexamined Patent Application Publication No. 2017-108369 can switch between a normal mode and a power-saving mode, identify identification information of a user who uses the image processing device, check the identification information against pre-registered identification information to identify the user in order to allow or disallow the use. Further, in a case where the image processing device itself or a portable terminal device is not in use, when determining that the detected user is a previous user, the image processing device displays an initial screen without executing personal authentication. In the case where the image processing device itself or the portable terminal device is not in use, when determining by a personal authentication unit that the detected user is not the previous user, the image processing device displays the initial screen after executing the personal authentication. Further, in the case where the image processing device itself or the portable terminal device is not in use, when no user is detected, the image processing device makes a transition to the power-saving mode.

When a user wants to use an information processing apparatus, it is required to put a user authentication module into operation so that user biological information can be acquired. On the other hand, there is a need to always operate the user authentication module in order to prepare for use of the information processing apparatus. Therefore, power consumption may unnecessarily increase.

### SUMMARY

This application has been made to solve the above problem, and an information processing apparatus according to the first aspect of this application includes: a chassis variable in form; a system device; a user authentication unit which changes the operating mode of the system device from a power-saving mode to a standard mode consumed more power when a user to be registered is identified using biological information as a pre-registered user; and a power supply circuit, wherein the user authentication unit is placed in the chassis, and the power supply circuit controls the supply of power to the user authentication unit based on the form.

The above information processing apparatus may further include a detection unit which detects whether or not the chassis has a form to open the user authentication unit for use, wherein when the chassis does not have the form to open the user authentication unit for use, the power supply circuit stops the supply of power to the user authentication unit, and when the chassis has the form to open the user authentication unit for use, the power supply circuit supplies power to the user authentication unit.

The above information processing apparatus may also be such that the power supply circuit includes a terminal to which a detection signal is input from the detection unit, as a voltage value indicating that the chassis has the form to open the user authentication unit for use, the detection signal has a voltage value higher than a voltage value indicating that the chassis does not have the form to open the user authentication unit for use, and a voltage from a voltage source is applied to the terminal.

The above information processing apparatus may further be such that the chassis includes a first chassis and a second chassis, the first chassis is rotatable relative to the second chassis, the user authentication unit is placed in a main surface of the first chassis, and the detection unit has a sensor to detect whether or not the first chassis is in proximity to the second chassis within a predetermined range.

Further, the above information processing apparatus may be such that when the first chassis is in proximity to the second chassis within the predetermined range, the system device changes the operating mode to the power-saving mode.

Further, the above information processing apparatus may be such that the user authentication unit includes a fingerprint sensor which acquires a fingerprint image representing a fingerprint, and a fingerprint recognition unit which determines whether or not the fingerprint image is a fingerprint image of the registered user.

A control method according to the second aspect of this application is a control method for an information processing apparatus including: a chassis variable in form; a system device; and a user authentication unit which changes the operating mode of the system device from a power-saving mode to a standard mode consumed more power when a user to be registered is identified using biological information as a pre-registered user, wherein the user authentication unit is placed in the chassis, the control method executing a step of causing the information processing apparatus to control the supply of power to the user authentication unit based on the form.

The above aspects of this application can reduce power consumption while enabling use of an information processing apparatus to be started at a desired time.

### BRIEF DESCRIPTION OF THE DRAWINGS

FIG. 1 is a perspective view illustrating an example of the appearance configuration of an information processing apparatus according to the present embodiment.

FIG. 2 is a sectional view illustrating an example of the information processing apparatus according to the present embodiment.

FIG. 3 is a schematic block diagram illustrating a hardware configuration example of the information processing apparatus according to the present embodiment.

FIG. 4 is an explanatory diagram for describing a power supply example according to the present embodiment.

FIG. 5 is a circuit diagram illustrating a configuration example of a feeder circuit according to the present embodiment.

FIG. 6 is a flowchart illustrating an operation control example according to the present embodiment.

FIG. 7 is a perspective view illustrating a modification of the information processing apparatus according to the present embodiment.

FIG. 8 is a sectional view illustrating the modification of the information processing apparatus according to the present embodiment.

FIG. 9 is a perspective view illustrating another modification of the information processing apparatus according to the present embodiment.

### DETAILED DESCRIPTION

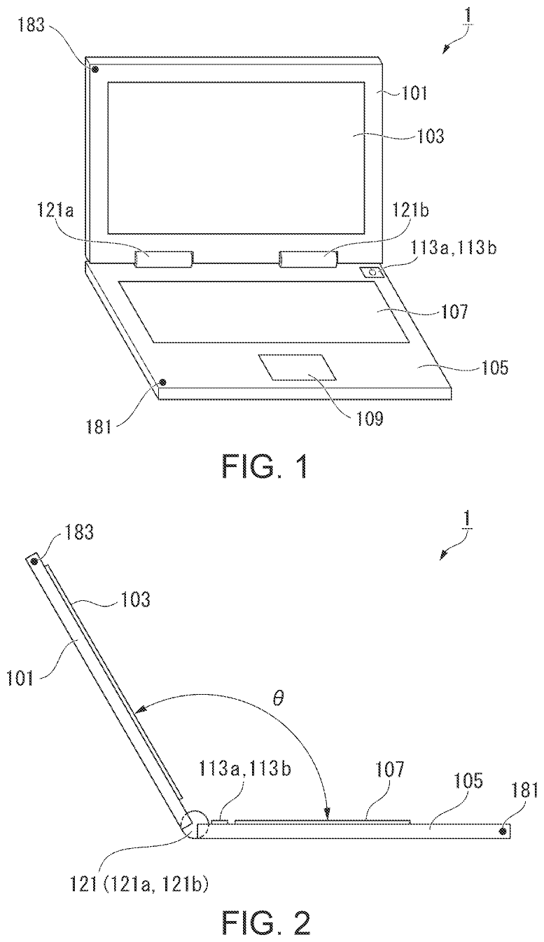

An embodiment of the present invention will be described below with reference to the accompanying drawings. First, the outline of an information processing apparatus 1 according to the present embodiment will be described. FIG. 1 is a perspective view illustrating an example of the appearance configuration of the information processing apparatus 1 according to the present embodiment. FIG. 2 is a sectional view illustrating a longitudinal section of the information processing apparatus 1 according to the present embodiment. In the example of FIG. 1 and FIG. 2, the information processing apparatus 1 is configured as a laptop personal computer (laptop PC).

The information processing apparatus 1 includes a first chassis 101 and a second chassis 105, which are coupled by using hinge mechanisms 121a and 121b. The hinge mechanisms 121a and 121b are fixed on one side of the first chassis 101 and on one side of the second chassis 105, respectively. One of the first chassis 101 and the second chassis 105 is rotatable relative to the other by using one side of the first chassis 101 and the second chassis 105 as an axis of rotation. In other words, an angle θ (called an “open angle” in this application) between the main surface of the first chassis 101 and the main surface of the second chassis 105 is variable.

A display 103 is placed on the main surface of the first chassis 101, which occupies most of the main surface. A keyboard 107, a touch pad 109, and a power button 113a are placed on the main surface of the second chassis 105. With such arrangement, the information processing apparatus 1 is used in such a state that the first chassis 101 and the second chassis 105 are in an open state. The open state is a state where either one of the main surface of the first chassis 101 and the main surface of the second chassis 105 is open without being shielded by the other. In the open state, the open angle θ is typically within a range of 90° to 180°.

In the second chassis 105, a lid sensor 181 is installed at a position closer to an opposite side than the one side as the axis of rotation. The lid sensor 181 is a magnetic sensor to detect a surrounding magnetic field. A permanent magnet 183 is installed at a position closer to an opposite side of the first chassis 101 than the one side thereof. In a state where the first chassis 101 is completely closed relative to the second chassis 105, that is, in a state where the open angle θ is 0°, the position of the permanent magnet 183 faces the position of the lid sensor 181. Therefore, the magnetic field detected by the lid sensor 181 is a clue to determine whether or not the permanent magnet 183 is in proximity to the lid sensor 181. Under such a form, whether or not the permanent magnet 183 is in proximity to the lid sensor 181 corresponds to whether or not the first chassis 101 is closed relative to the second chassis 105.

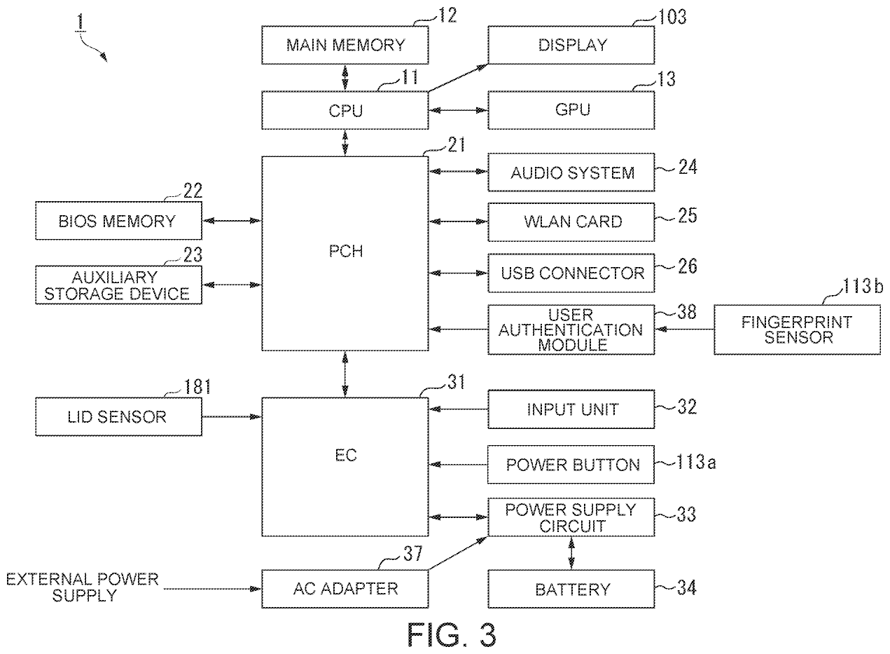

As will be described later, the information processing apparatus 1 includes a fingerprint sensor 113b. A user access the fingerprint sensor 113b provided together with the power button 113a, that is, the user operates the power button 113a with a finger. The fingerprint sensor 113b provided together with the power button 113a acquires a fingerprint of the user's fingertip touching on the fingerprint sensor 113b. A user authentication module 38 (FIG. 3) uses the acquired fingerprint to execute user authentication. In the user authentication, the user authentication module 38 can check the acquired fingerprint against a pre-registered fingerprint of a registered user to determine whether or not the user acquired using a known fingerprint authentication method to be the registered user.

When the first chassis 101 changes from the open state to the closed state relative to the second chassis 105, the information processing apparatus 1 changes the operating mode from a normal mode to a power-saving mode. The normal mode is an operating mode with standard power consumption. The power-saving mode is an operating mode in which power consumption is lower than the power consumption in the normal mode. In the power-saving mode, the supply of power to the user authentication module 38 is stopped in principle.

The information processing apparatus 1 includes a power supply circuit 33 (FIG. 3). The power supply circuit 33 can supply power required for each device. When the first chassis 101 changes from the closed state to the open state relative to the second chassis 105, the power supply circuit 33 energizes the user authentication module 38 to start the operation. When the identification of the registered user is successful, the user authentication module 38 changes the operating mode of the information processing apparatus 1 from the power-saving mode to the normal mode.

Next, a hardware configuration example of the information processing apparatus 1 according to the present embodiment will be described. FIG. 3 is a schematic block diagram illustrating the hardware configuration example of the information processing apparatus 1 according to the present embodiment. The information processing apparatus 1 includes a CPU 11, a main memory 12, a GPU (Graphics Processing Unit) 13, the display 103, a PCH (Platform Controller Hub) 21, a BIOS (Basic Input Output System) memory 22, an auxiliary storage device 23, an audio system 24, a WLAN (Wireless Local Area Network) card 25, a USB (Universal Serial Bus) connector 26, an EC (Embedded Controller) 31, an input unit 32, the power supply circuit 33, a battery 34, an AC (Alternating Current) adapter 37, the power button 113a, the fingerprint sensor 113b, and the lid sensor 181.

The CPU 11 is a processor that forms the core of a system device included in the information processing apparatus 1. The CPU 11 is a processor capable of executing various kinds of arithmetic processing directed by commands written in various programs. For example, the CPU 11 executes processing instructed by various programs, such as an OS (Operating System), a BIOS, firmware, and application programs (called “apps” in this application).

The CPU 11 executes the OS to provide a computer system that forms the core of the information processing apparatus 1, that is, to provide functions such as resource management in a host system, execution management of various programs, input/output control, and file management. The fact that processing directed by commands written in programs is executed may also called “execution of programs” or “executing programs.”

The main memory 12 is a writable memory used as reading areas of execution programs of the processor or working areas to which processing data of the execution programs are written. The main memory 12 is configured, for example, to include plural DRAM (Dynamic Random Access Memory) chips. The execution programs include the OS, various drivers for operating hardware such as peripheral devices, various services/utilities, apps, and the like.

The GPU 13 is a processor that mainly executes real-time image processing. The GPU 13 processes a drawing command from the CPU 11 and writes drawing information obtained by the processing into a video memory (not illustrated). The GPU 13 reads the drawing information from the video memory, and outputs display data indicative of the drawing information to the display 103 via the CPU 11 (image processing). The drawing information notified to the display 103 configures a display screen.

The CPU 11 executes a graphics driver on the OS to control the operation of the GPU 13 in order to realize image processing instructed by the OS, apps, and other programs. The number of GPUs 13 is not limited to one, which may be two or more. The GPU 13 may also share some processing with the CPU 11 to execute parallel arithmetic processing other than the image processing.

The CPU 11, the main memory 12, and the GPU 13 function as a computer system, that is, a system device that forms a host system as the core of the information processing apparatus 1. In other words, the computer system of the information processing apparatus 1 is configured to include the system device as hardware, the OS, and software such as Schedule Task.

The display 103 displays a display screen based on the display data output from the CPU 11. For example, the display 103 may be any of a liquid crystal display (LCD), an OLED (Organic Light Emitting Diode) display, and the like.

The PCH 21 includes one or more bus controllers to be connectable with plural devices so that various data can be input and output. For example, each bus controller may be any one of USB, a serial ATA (Advanced Technology Attachment) bus, an SPI (Serial Peripheral Interface) bus, a PCI (Peripheral Component Interconnect) bus, a PCI-Express bus, and an LPC (Low Pin Count) bus, or any combination thereof. The plural devices as connection destinations correspond, for example, to the BIOS memory 22, the auxiliary storage device 23, the WLAN card 25, the USB connector 26, and the EC 31.

The BIOS memory 22 stores the BIOS, firmware for controlling the operation of the EC 31 and other devices, and the like. The BIOS is firmware for performing basic input and output of the system device. In this application, the BIOS can include firmware defined according to the UEFI (Unified Extensible Firmware Interface) specification. The BIOS memory 22 is configured to include electrically rewritable non-volatile memories. As such non-volatile memories, for example, an EEPROM (Electrically Erasable Programmable Read Only Memory), a flash ROM (Read Only Memory), and the like can be used.

The auxiliary storage device 23 continuously stores various data. The stored data include various programs capable of being executed by the CPU 11 and the GPU 13, parameters, data used for various processing, and data acquired by various processing. For example, the auxiliary storage device 23 may be either one of an HDD (Hard Disk Drive) and an SSD (Solid State Drive). The auxiliary storage device 23 is configured to include various non-volatile memories. As a non-volatile memory, for example, a flash memory is used. In the various programs, for example, any one of the OS, drivers, firmware, apps, and the like, or any combination thereof can be included.

A microphone (not illustrated) and a speaker (not illustrated) are connected to the audio system 24 so that recording, playing back, and outputting audio data can be executed. Note that the microphone and the speaker may be, for example, incorporated in the information processing apparatus 1, or may be provided separately from the information processing apparatus 1.

The WLAN card 25 is connected to a wireless LAN or any other network via the wireless LAN so that various data can be transmitted and received with devices as connection destinations.

The USB connector 26 is a connector for connecting various peripheral devices using USB.

The EC 31 is a one-chip microcomputer which monitors and controls the status of various devices (peripheral devices, sensors, and the like) regardless of the operating state of the host system that forms the core of the information processing apparatus 1. The EC 31 includes a ROM, multi-channel A/D (Analog-to-Digital) input terminal and D/A (Digital-to-Analog) output terminal, a timer, and input/output interfaces (not illustrated) in addition to a processor separate from the CPU 11 and a RAM separate from the main memory 12. The EC 31 executes predetermined firmware to play its function.

Devices such as the input unit 32, the power supply circuit 33, the power button 113a, and the lid sensor 181 are connected by wire to the input/output interfaces of the EC 31. The EC 31 can control the operation of these devices. The input/output interfaces may also be connected wirelessly to the various devices in a manner to be able to transmit and receive data. The input unit 32 may also be connected wirelessly to the EC 31 using the input/output interfaces. For example, the input/output interfaces may realize wireless connections using a short-range wireless communication method defined in IEEE802.15.1.

The input unit 32 includes input devices that detect user operations and output, to the EC 31, an operation signal generated according to the detected operations. For example, the input devices that construct the input unit 32 correspond to the keyboard 107 and the touch pad 109. A touch sensor may further be included in the input unit 32. This touch sensor may be configured as a touch panel which overlaps the display 103 that constructs a display unit.

Under the control of the EC 31, the power supply circuit 33 supplies power required for the operation of each device included in the information processing apparatus 1. Devices as power supply destinations include peripheral devices in addition to the system device and the user authentication module 38. Further, peripheral devices connected to the USB connector 26 can also be power supply destinations. The device operating voltage can be different for each individual device. In various devices, a device that requires multi-stage voltages can be included. A reference voltage may be included as the multi-stage voltages in addition to the operating voltage.

The power supply circuit 33 includes a converter for converting power supplied to the own unit into a voltage, and a feeder for feeding, to the battery 34, the power with the voltage converted. When power is supplied from the AC adapter 37, the feeder supplies, to the battery 34, power left unconsumed in each device. When power is not supplied from the AC adapter 37, or when the power supplied from the AC adapter 37 is insufficient as power consumed by each device, power discharged from the battery 34 is supplied to each device as operating power.

As the converter, for example, one or more DC/DC converters are used. Each of the plural DC/DC converters may be used properly for each voltage after being converted. Further, a first kind of converters as some of the plural DC/DC converters may be connected to devices that can be different in operating state according to the system device or the operating mode of the system device. The first kind of converters may control power to be supplied based on the operating mode notified from the EC 31. A second kind of converters as some others of the plural DC/DC converters may be connected to devices that operate regardless of the operating mode of the system device. The second kind of converters may be able to supply constant power regularly.

The power supply circuit 33 includes, for example, a VCC3M power supply, a VCC5M power supply, and a VCC3UC power supply. The VCC3M power supply and the VCC5M power supply correspond to the first kind of converters. The voltages of the VCC3M power supply and the VCC5M power supply after being converted are 3 V and 5 V, respectively, to supply power to devices required for power with voltages of 3 V and 5 V, respectively. The VCC3UC power supply corresponds to the second kind of converter. The voltage of the VCC3UC power supply after being converted is 3 V to supply power to devices required for power of 3 V and operated regardless of the operating mode of the system device. As the devices operated regardless of the operating mode of the system device, for example, there are the EC 31, the audio system 24, the WLAN card 25, USB devices connected to the USB connector 26, and the like.

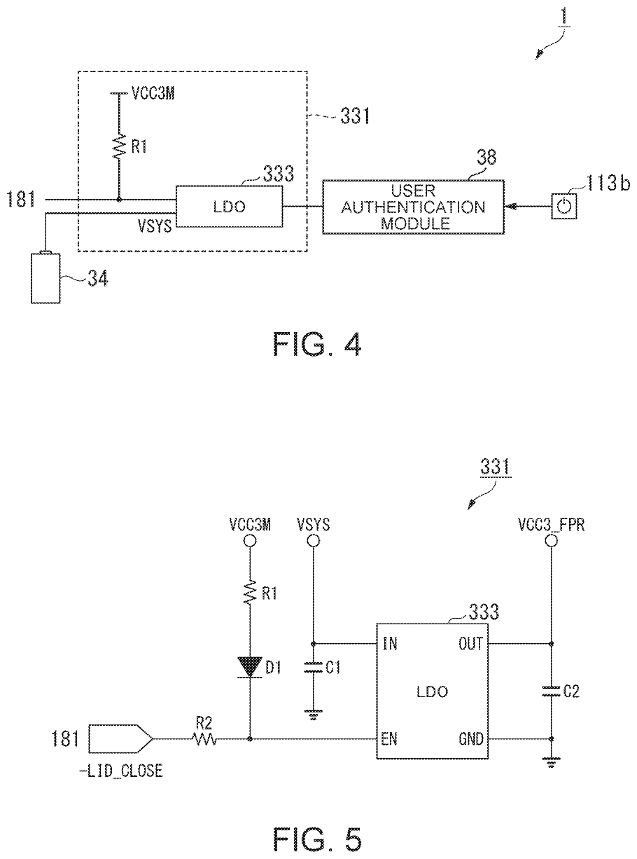

The power supply circuit 33 includes a feeder circuit 331 (FIG. 4 and FIG. 5). The feeder circuit 331 controls the power supply of the user authentication module 38 based on a detection signal input from the lid sensor 181 to be described later.

Note that the power consumption of the system device occupies most of the power consumption of the information processing apparatus 1. The power consumption of the system device is significantly different depending on the operating mode. As operating modes, there are at least a standard mode and a power-saving mode. The standard mode is an operating mode in which the power consumption of the CPU 11 is standard. The power-saving mode is an operating mode lower in power consumption than the standard mode. In the power-saving mode, the operation of some peripheral devices is stopped. In the power-saving mode, for example, the display 103 is included as the peripheral devices the operation of which is stopped.

Based on the detection signal input from the lid sensor 181, the EC 31 detects whether the first chassis 101 is in the closed state relative to the second chassis 105 (which may be simply called the “closed state” in the following description) or the first chassis 101 is in the open state relative to the second chassis 105 (which may be simply called the “open state” in the following description). When detecting a change from the open state to the closed state, the EC 31 notifies the CPU 11 of open/closed information indicative of the change. When the open/closed information is input from the EC 31, the CPU 11 changes the operating mode from the standard mode to the power-saving mode.

In the present embodiment, for example, S0 mode defined in the ACPI (Advanced Configuration and Power Interface) specification is used as the standard mode, and S5 mode is used as the power-saving mode. S5 mode is a shutdown state where the OS is shut down to power off. The transition from S0 mode to S5 mode is accompanied by a process of stopping input and output with peripheral devices except for a specific device(s), a process of stopping the execution of programs other than the OS, a process of stopping the operation of the peripheral devices, a process of transferring data stored in the main memory 12 to the auxiliary storage device 23 as backup data, and a process of stopping the execution of the OS by the CPU 11.

In the present embodiment, the operation of the user authentication module 38 is stopped in the power-saving mode. At this time, the power supply circuit 33 stops the supply of power to the user authentication module 38. However, the power supply circuit 33 waits for a detection signal input from the lid sensor 181. Based on the detection signal input from the lid sensor 181, the power supply circuit 33 detects whether the first chassis 101 is in the closed state or the open state relative to the second chassis 105. When detecting that the first chassis 101 changes from the closed state to the open state relative to the second chassis 105, the power supply circuit 33 resumes the supply of power to the user authentication module 38.

When authentication result information indicative of the success of user authentication is input from the user authentication module 38, the EC 31 notifies the power supply circuit 33 of the standard mode as the operating mode.

The power supply circuit 33 resumes the supply of power corresponding to the standard mode as the operating mode notified from the EC 31. The transition from S5 mode to S0 mode is accompanied by a process of resuming the execution of the OS by the CPU 11, a process of transferring the backup data from the auxiliary storage device 23 to the main memory 12, a process of recognizing the peripheral devices, a process of resuming the operation of the peripheral devices, and a process of resuming the execution of programs other than the OS. After that, the CPU 11 outputs, to the user authentication module 38, an operating mode notification indicative of the standard mode as the operating mode. User authentication information is input from the user authentication module 38 to the CPU 11, and the CPU 11 performs login processing using the input user authentication information. After completion of the login processing, the CPU 11 resumes access from the user (one-touch authentication (single press recognition)).

Under the control of the power supply circuit 33, the battery 34 stores power supplied from the power supply circuit 33. The battery 34 discharges part of the stored power to the power supply circuit 33. A secondary battery is used as the battery 34. The secondary battery is a storage battery that can be charged and discharged. The secondary battery is, for example, a lithium-ion battery.

The AC adapter 37 converts AC power supplied from an external power supply to DC power with constant voltage, and supplies the converted power to the power supply circuit 33. The AC adapter 37 has a mounting fixture detachable from the chassis of the information processing apparatus 1 including the power supply circuit 33. The mounting fixture includes an interface capable of transmitting both power and data according to a predetermined standard. As the predetermined standard, for example, USB Type-C can be used.

The user authentication module 38 acquires user biological information from the fingerprint sensor 113b and performs user authentication using the acquired biological information to determine the success or failure of the user authentication based on whether or not the user to be registered as the acquisition source of the biological information is a pre-registered, legitimate user. When the user authentication is successful, the user authentication module 38 outputs, to the PCH 21, authentication result information indicating that the user authentication is successful. User authentication information (for example, login password) of the registered user is preset in the user authentication module 38 in association with the registered user biological information. When an operating mode notification is input from the CPU 11 to the user authentication module 38, the user authentication module 38 outputs, to the CPU 11, user authentication information set for the registered user. The CPU 11 performs login processing using the user authentication information input from the user authentication module 38.

The user authentication module 38 is connected to a sensor for acquiring user biological information. In the example of FIG. 1 to FIG. 3, the user authentication module 38 is a fingerprint recognition (FPR) module connected to the fingerprint sensor 113b. The fingerprint recognition module uses a fingerprint as the user biological information. The fingerprint recognition module includes, for example, a fingerprint recognition unit, and a recognition information processing unit. The fingerprint sensor 113b is a sensor to acquire a fingerprint image representing a fingerprint of a finger touching on the own unit. The fingerprint recognition unit uses a known fingerprint recognition method to check the acquired fingerprint image against a pre-registered fingerprint image of the registered user in order to determine whether or not the acquired fingerprint image is the fingerprint image of the registered user. When the acquired fingerprint image is the fingerprint image of the registered user, the fingerprint recognition unit can determine that the user authentication is successful and identify the registered user. The fingerprint image and user authentication information (for example, login password) of the registered user are pre-registered in the fingerprint recognition unit. The fingerprint recognition unit can identify user authentication information of the identified, registered user.

The lid sensor 181 detects whether or not the first chassis 101 is in the closed state relative to the second chassis 105, and outputs, to the power supply circuit 33, a detection signal indicative of whether or not the first chassis 101 is in the closed state. In the example of FIG. 1 to FIG. 3, the lid sensor 181 includes a magnetic sensor to detect the strength of a magnetic field produced by the permanent magnet 183. The lid sensor 181 includes, for example, a Hall element to convert the strength of the magnetic field to a voltage. The lid sensor 181 generates a detection signal indicative of whether the first chassis 101 is in the closed state or the open state relative to the second chassis 105 based on whether or not the voltage corresponding to the detected strength of the magnetic field is higher than a predetermined detection threshold value. As the detection threshold value, for example, a voltage detected when the open angle θ between the first chassis 101 and the second chassis 105 is in a range of 30° to 60° is set.

Next, a configuration example of the feeder circuit 331 according to the present embodiment will be described mainly about the supply of power to the user authentication module 38. FIG. 4 illustrates the configuration example of the feeder circuit 331 according to the present embodiment.

The feeder circuit 331 includes a low-dropout (LDO) regulator 333. When the detection signal indicates the open state, the LDO 333 converts a voltage VSYS of power, supplied from the battery 34 or the AC adapter 37 as a system power supply, to an operating voltage VCC3_FPR of the user authentication module 38, and supplies, to the user authentication module 38, power having the converted operating voltage VCC3_FPR. In the example of FIG. 4, the illustration of the AC adapter 37 is omitted. When the detection signal indicates the closed state, the LDO 333 does not supply power to the user authentication module 38.

Based on the detection signal, the LDO 333 controls whether or not to supply power to the user authentication module 38. In the example of FIG. 4 and FIG. 5, the detection signal is such that a voltage value −LID_CLOSE indicative of the open state of the first chassis 101 relative to the second chassis 105 has a positive voltage value higher than a voltage value indicative of the closed state of the first chassis 101 relative to the second chassis 105. The detection signal can also be regarded as a binary logical signal indicative of whether or not the first chassis 101 is in the open state relative to the second chassis 105. The voltage value −LID_CLOSE corresponds to a logical negation of a voltage value LID_CLOSE indicative of the closed state. The voltage value LID_CLOSE indicative of the closed state may be 0 V as the ground potential or may approximate 0 V. Further, the LDO 333 is grounded.

One end of a resistance element R1 is connected to a control end to which the detection signal is input, and a voltage source is connected to the other end of the resistance element R1. In the example of FIG. 4 and FIG. 5, the VCC3M power supply is applied as the voltage source. A voltage of 3 V is applied to the other end of the resistance element R1. The resistance element R1 functions as a pull-up resistance by dividing the applied voltage and applying the divided voltage to the control end. Therefore, a positive potential significantly higher than 0 V is held at the control end. At the control end, the voltage value −LID_CLOSE of the detection signal indicative of the open state of the first chassis 101 relative to the second chassis 105 is significantly higher than the voltage value of the detection signal indicative of the closed state. Since the effect of noise on the potential at the control end is reduced, control of the presence or absence of power supply to the user authentication module 38 based on a potential difference between the supplied voltage VSYS and the voltage of the detection signal is ensured.

Note that the CPU 11 has a device management function (device manager). The device management function includes a process of detecting a connection state of each individual device. An input end of the LDO 333 is set in the CPU 11 as a reference destination of the operating state of the user authentication module 38, and the voltage at the input end is monitored. With the above configuration, the voltage at the reference destination regardless of the presence or absence of power supply to the user authentication module 38 is significantly higher than 0 V. Therefore, even when power supply to the user authentication module 38 is stopped, the user authentication module 38 is not lost.

Next, a configuration example of the feeder circuit 331 according to the present embodiment will be described. FIG. 5 is a circuit diagram illustrating the configuration example of the feeder circuit 331 according to the present embodiment.

The feeder circuit 331 includes the LDO 333, resistance elements R1 and R2, a rectifier element D1, and capacitive elements C1 and C2.

The LDO 333 has an input end IN, a control end EN, an output end OUT, and a ground end GND. When the voltage of the detection signal input to the control end EN is a significantly positive value, the LDO 333 converts the supplied voltage VSYS of power, supplied to the input end IN, to the operating voltage VCC3_FPR to supply power having the operating voltage VCC3_FPR from the output end OUT to the user authentication module 38. When the voltage of the detection signal input to the control end EN is 0 V or approximates 0 V, the LDO 333 does not supply power from the output end OUT.

One end of the capacitive element C1 is connected to the input end IN, and the other end of the capacitive element C1 is grounded. Therefore, the potential at the input end IN is held to be a positive value significantly higher than 0 V.

The control end EN is connected to the other end of the resistance element R2 and a negative-electrode terminal of the rectifier element D1. The other end of the resistance element R1 is connected to a positive-electrode terminal of the rectifier element D1, and the power supply-voltage VCC3M is applied from the voltage source to one end of the resistance element R1. Since the power supply-voltage VCC3M is further applied to the control end EN through the rectifier element D1, a backflow of current, which can be caused by a change in voltage value of the detection signal, from the control end EN to the voltage source is prevented. Therefore, the potential at the control end EN is stabilized.

The detection signal is input from the lid sensor 181 to one end of the resistance element R2. The voltage value of the detection signal is adjusted by dividing the voltage in the resistance element R2, and a voltage value after being adjusted is applied to the control end EN.

One end of the capacitive element C2 is connected to the output end OUT, and the other end of the capacitive element C2 is grounded. Therefore, the potential at the output end is held to be a positive value significantly higher than 0 V.

Further, the ground end GND is grounded.

Note that in the example of FIG. 4 and FIG. 5, the case of using the VCC3M power supply as the voltage source is raised, but any power supply that can give the system input VCC_IN other than the VCC3M power supply, such as a VCC5M power supply or a VCC3US power supply, may also be used.

The voltage source may not necessarily be a component of the power supply circuit 33. As the voltage source, an input/output end electrically connected to a connecting point at which the potential is significantly higher than 0 V among input/output ends (I/O ports (Input-output ports)) of the EC 31 or the CPU 11 may be used. The EC 31 operates regardless of the operating mode of the host system. The CPU 11 is supplied with power sufficient to be able to start processing related to a change in at least the operating mode even in the power-saving mode.

Otherwise, an operating state signal (enable signal) indicative of the operating state of a predetermined operating device that operates even when the first chassis 101 is closed relative to the second chassis 105 may be used as the voltage source. The operating state signal is acquired from an output end of the operating device. As the operating device, for example, any one of the audio system 24, the WLAN card 25, USB devices connected to the USB connector 26, and the like may be applied.

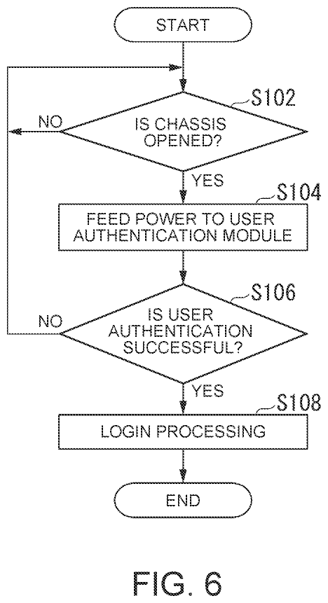

Next, an operation control example according to the present embodiment will be described. FIG. 6 is a flowchart illustrating the operation control example according to the present embodiment.

(Step S102) The LDO 333 of the feeder circuit 331 waits for a detection signal indicative of whether or not the first chassis 101 is in the open state relative to the second chassis 105. When a detection signal indicating that the first chassis 101 is in the open state is input (YES in step S102), the LDO 333 proceeds to a process in step S104. When the detection signal indicating that the first chassis 101 is in the open state is not input (NO in step S102), the LDO 333 repeats the process in step S102.

(Step S104) The LDO 333 converts a supplied voltage to a predetermined operating voltage for the user authentication module 38 to start feeding power to the user authentication module 38. After that, the operation of the user authentication module 38 is started.

(Step S106) The user authentication module 38 waits for a fingerprint image of a finger touching on the fingerprint sensor 113b, and when acquiring the fingerprint image, the user authentication module 38 performs user authentication processing on the acquired fingerprint image. The user authentication module 38 determines the success or failure of the user authentication based on whether or not the acquired fingerprint image is a pre-registered fingerprint image of a registered user. When the user authentication is successful (YES in step S106), the user authentication module 38 proceeds to a process in step S108. When the user authentication is unsuccessful (NO in step S106), the procedure returns to the process in step S102.

(Step S108) The CPU 11 performs login processing using the authentication information provided by the user authentication module 38. After that, the processing of FIG. 6 is ended.

The form of the chassis of the information processing apparatus 1 is not limited to this form, and it may also be any other form as long as the fingerprint sensor 113b is variable from a form where the fingerprint sensor 113b is opened for use (accessible by a user) without being shielded by any other part to a form where the fingerprint sensor 113b is shielded by the other part and is not opened for use, or vice versa. The information processing apparatus 1 just has to include a detection unit for detecting whether or not the chassis has a form to open the fingerprint sensor 113b for use (accessible by a user).

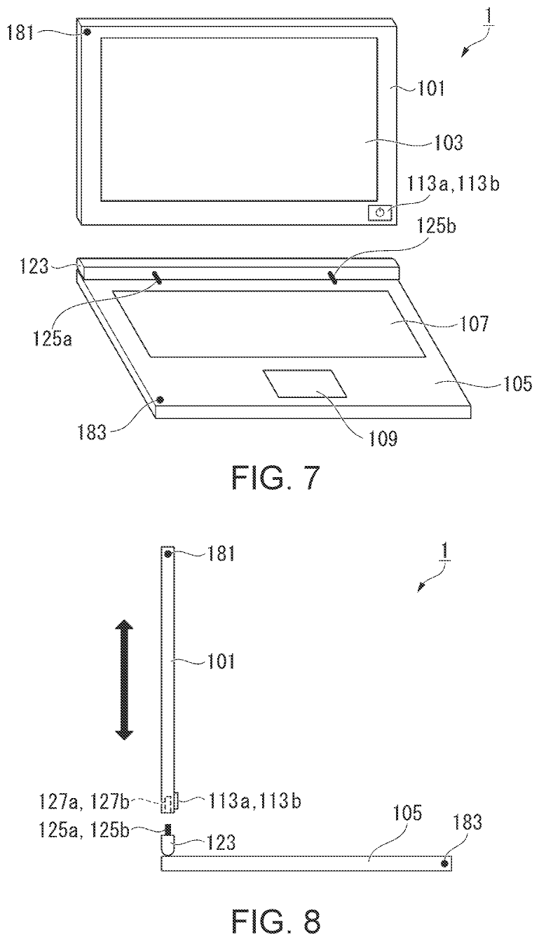

For example, in a modification illustrated in FIG. 7 and FIG. 8, the first chassis 101 is configured to be detachable from the second chassis 105. A connector 123 is provided in a position closer to one side than the opposite side of the second chassis 105. The connector 123 is so installed that the longitudinal direction thereof is set in a direction toward one side of the second chassis 105. A pair of right and left guide projections 125a and 125b are provided on a side face of the connector 123. A pair of right and left guide recesses 127a and 127b are provided in a side face parallel to one side of the first chassis 101. The guide projections 125a and 125b or guide projections of any other device configured to have the same shape and the same pitch as those of the guide projections 125a and 125b are detachably fitted into the guide recesses 127a and 127b. Further, the fingerprint sensor 113b is placed on the first chassis 101. Although the positional relationship of the lid sensor 181 and the permanent magnet 183 are opposite to that illustrated in FIG. 1 and FIG. 2, it is also detected whether or not the first chassis 101 is in the open state relative to the second chassis 105.

In this modification, most of devices including the system device are stored in the first chassis 101. When the first chassis 101 is attached to the second chassis 105 and the first chassis 101 is in the closed state relative to the second chassis 105, the fingerprint sensor 113b provided together with the power button 113a is shielded by the second chassis 105 and does not become the open state. Therefore, the feeder circuit 331 does not feed power to the user authentication module 38, and hence the user authentication module 38 does not operate.

When the first chassis 101 is attached to the second chassis 105 and the first chassis 101 is in the open state relative to the second chassis 105, or when the first chassis 101 is detached from the second chassis 105, the fingerprint sensor 113b is opened for use to appear on the outside. In this state, the user authentication module 38 can acquire a fingerprint image as user biological information to execute user authentication using the acquired fingerprint image. In this state, the feeder circuit 331 feeds power to the user authentication module 38.

Therefore, a first electrode and a second electrode may be installed at one of guide projections 125a and 125b and in one of guide recesses 127a and 127b, respectively. The feeder circuit 331 may also include a generation circuit for generating a conduction signal as an electrical signal indicative of the presence or absence of conduction between the first electrode and the second electrode, a NOT circuit (NOT) to give logical negation (NOT) to the conduction signal, and an OR circuit (OR) to give logical addition (OR) between the logical NOT and the detection signal from the lid sensor 181. In this case, an OR signal output from the OR circuit has only to be input to one end of the resistance element R2 (FIG. 5).

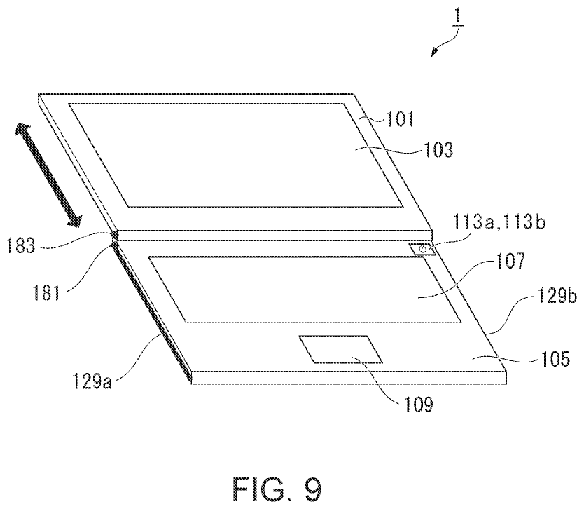

Further, in the information processing apparatus 1 according to another modification illustrated in FIG. 9, the position of the first chassis 101 relative to the second chassis 105 may be variable while maintaining the orientations of the respective main surfaces. In the information processing apparatus 1 according to this modification, sliders 129a and 129b as supports for supporting the first chassis 101 to be movable in the length direction while covering the main surface of the second chassis 105 are attached to the side faces of the second chassis 105. When a displacement of the position of the first chassis 101 in the length direction from the position in which the first chassis 101 completely overlaps the second chassis 105 is a certain distance or more, the fingerprint sensor 113b placed on the main surface of the second chassis 105 is opened for use without being shielded by the first chassis 101. When the displacement is less than the certain distance, the fingerprint sensor 113b is shielded by the first chassis 101 and is not opened. In this modification, the lid sensor 181 is placed in the main surface of the second chassis 105, and the permanent magnet 183 is placed in the back surface of the first chassis 101. When the positional relationship between the first chassis 101 and the second chassis 105 is a positional relationship to open the fingerprint sensor of the power button 113a, the lid sensor 181 and the permanent magnet 183 are placed in positions to face each other. With such a configuration, it is detectable whether or not the fingerprint sensor 113b is opened for use.

Note that the first chassis 101 may be detachable from the second chassis 105 in this modification. In this case, like as illustrated in FIG. 7 and FIG. 8, attaching/detaching of the first chassis 101 may be further detectable so that a state where the first chassis 101 is attached and the first chassis 101 is closed relative to the second chassis 105, and the other state are identifiable. The other state corresponds to the state where the fingerprint sensor 113b is opened for use.

Note that the case where the user authentication module 38 uses the fingerprint image as the biological information in the user authentication processing is taken as an example in the above description, but the present invention is not limited to this case. The user authentication module 38 can also acquire other kinds of biological information, such as a pupil image or a vein pattern, by physical contact or approach of the user, thus enabling use of biological information using any user-specific pattern.

The number of members that construct the chassis is not limited to two, and it may be one, or three or more. Each individual member is not limited to a rigid body, and it may be an elastic body.

The detection unit for detecting the form of the chassis is not necessarily limited to the lid sensor 181 or any other magnetic sensor. A detection unit based on any other detection principle (for example, an angle sensor for detecting an angle between members, a stress sensor for detecting a stress generated between the members, or the like) may be adopted as long as it can be detected whether or not to have a form where the sensor for acquiring user biological information installed in the chassis is opened for use.

The power-saving mode is not limited to S5 mode defined in the ACPI specification, and it may be any other sleeping mode, such as S3 mode or S4 mode.

Further, the case where the information processing apparatus 1 is configured as the laptop PC is taken as an example in the above description, but the present invention is not limited to this case. For example, the information processing apparatus 1 may also be configured as a mobile phone.

As described above, the information processing apparatus 1 according to the present embodiment includes: a chassis (for example, the first chassis 101 and the second chassis 105) variable in form; the system device (for example, the CPU 11 and the main memory 12); the user authentication unit (for example, the user authentication module 38) to change the operating mode of the system device from the power-saving mode to the standard mode consumed more power when a user to be registered is identified using biological information as a pre-registered user; a sensor (for example, the fingerprint sensor 113b) connected to user authentication unit for acquiring user biological information; and the power supply circuit 33, wherein the user authentication unit is placed in the chassis. The power supply circuit 33 controls the supply of power to the user authentication unit based on the form of the chassis.

With this configuration, the operating state of the user authentication unit is controlled based on the form of the chassis, the registered user can be identified based on the biological information by deforming the chassis, and when the registered user is identified, the operating mode of the system device is changed from the power-saving mode to the standard mode. Power consumption can be reduced and the information processing apparatus 1 is made available at a user's desired time by stopping the supply of power to the user authentication unit when the operating mode of the system device is in the power-saving mode.

The information processing apparatus 1 may also include a detection unit (for example, the lid sensor 181) to detect whether or not the chassis has a form to open the sensor for acquiring user biological information for use. When the chassis does not have the form to open the sensor for acquiring user biological information for use, the power supply circuit 33 may stop the supply of power to the user authentication unit, while when the chassis has the form to open the sensor for acquiring user biological information for use, the power supply circuit 33 may supply power to the user authentication unit.

With this configuration, when the chassis does not have the form to open the sensor for acquiring user biological information for use, the supply of power to the user authentication unit is stopped, while when the chassis has the form to open the sensor for acquiring user biological information for use, power is supplied to the user authentication unit. When the chassis has the form to open the sensor for acquiring user biological information for use, the user authentication unit can acquire user biological information to execute user authentication processing based on the acquired biological information. By changing the chassis to have the form to open the sensor for acquiring user biological information for use, the user can cause the user authentication unit to execute user authentication processing without performing any other operation, and when the legitimate registered user is identified, the information processing apparatus 1 can be made available.

The power supply circuit 33 may also have a terminal (for example, the control end EN) to which a detection signal is input from the detection unit. As a voltage value indicating that the chassis has the form to open the sensor for acquiring user biological information for use, the detection signal may have a voltage value (for example, −LID_CLOSE) higher than a voltage value indicating that the chassis does not have the form to open the sensor for acquiring user biological information for use, and a voltage of the voltage source (for example, the VCC3M power supply) may be applied to the terminal.

With this configuration, the potential at the terminal to which the detection signal is input can be kept high. Therefore, since the effect of noise on the terminal can be reduced, the state where the chassis has the form to open the sensor for acquiring user biological information for use can be identified by the higher voltage value.

The chassis may include the first chassis 101 and the second chassis 105 in such a manner that the first chassis 101 is rotatable relative to the second chassis 105. The sensor for acquiring user biological information may be installed in the main surface of the first chassis, and the detection unit may have a sensor (for example, the lid sensor 181) to detect whether or not the first chassis 101 is in proximity to the second chassis 105 within a predetermined range.

With this configuration, when the open state of the first chassis 101 relative to the second chassis 105 is detected from the closed state, the sensor for acquiring user biological information is opened for use to acquire the biological information used in the user authentication processing. Therefore, the user can perform an operation in the state where the first chassis 101 is in the open state relative to the second chassis 105 to make biological information of the user himself or herself acquirable so that the information processing apparatus 1 can be made available.

When the first chassis is in proximity to the second chassis within the predetermined range, the system device may change the operating mode to the power-saving mode.

With this configuration, in the closed state of the first chassis 101 relative to the second chassis, the operating mode of the system device is the power-saving mode. Therefore, since power consumption is reduced when the user is not using the information processing apparatus 1, convenience is not impaired.

The sensor for acquiring user biological information may include a fingerprint sensor for acquiring a fingerprint. The user authentication unit may include a fingerprint recognition unit which determines whether or not the fingerprint image is a fingerprint image of a registered user.

With this configuration, it is identified whether or not the user is the registered user based on the fingerprint image of the user. Therefore, the user can make the information processing apparatus 1 available just by deforming the form of the chassis and touching the fingerprint sensor with a fingertip.

While the embodiment of this invention has been described in detail above with reference to the accompanying drawings, the specific configurations are not limited to those in the embodiment described above, and design changes are included without departing from the scope of this invention. The respective configurations in the embodiment described above can be combined arbitrarily.

### DESCRIPTION OF SYMBOLS

1 information processing apparatus
11 CPU
12 main memory
13 GPU
21 PCH
22 BIOS memory
23 auxiliary storage device
24 audio system
25 WLAN card
26 USB connector
31 EC
32 input unit
33 power supply circuit
34 battery
37 AC adapter
38 user authentication module
101 first chassis
103 display
105 second chassis
113a power button
123 connector
125 (125a, 125b) guide projection
127 (127a, 127b) guide recess
129 (129a, 129b) slider
181 lid sensor
183 permanent magnet
331 feeder circuit
333 LDO
C1, C2 capacitive element
D1 rectifier element
R1, R2 resistance element

What is claimed is:

1. An information processing apparatus comprising:
a chassis variable in form;
a system device;
a sensor for acquiring biological information;
a user authentication unit which changes an operating mode of the system device from a power-saving mode to a standard mode consumed more power when a user to be registered is identified using the biological information as a pre-registered user; and
a power supply circuit, wherein
the sensor is placed in the chassis, and
the power supply circuit controls supply of power to the user authentication unit based on the form.

2. The information processing apparatus according to claim 1, further comprising
a detection unit which detects whether or not the chassis has a form to open the sensor for use, wherein
when the chassis does not have the form to open the sensor for use, the power supply circuit stops the supply of power to the user authentication unit, and
when the chassis has the form to open the sensor for use, the power supply circuit supplies power to the user authentication unit.

3. The information processing apparatus according to claim 2, wherein
the power supply circuit includes a terminal to which a detection signal is input from the detection unit,
as a voltage value indicating that the chassis has the form to open the sensor for use, the detection signal has a voltage value higher than a voltage value indicating that the chassis does not have the form to open the sensor for use, and
a voltage from a voltage source is applied to the terminal.

4. The information processing apparatus according to claim 2, wherein
the chassis includes a first chassis and a second chassis,
the first chassis is rotatable relative to the second chassis,
the user authentication unit is placed in a main surface of the first chassis, and
the detection unit has a sensor to detect whether or not the first chassis is in proximity to the second chassis within a predetermined range.

5. The information processing apparatus according to claim 4, wherein when the first chassis is in proximity to the second chassis within the predetermined range, the system device changes the operating mode to the power-saving mode.

6. The information processing apparatus according to claim 1, wherein
the sensor for acquiring biological information includes a fingerprint sensor which acquires a fingerprint image representing a fingerprint, and
the user authentication unit includes a fingerprint recognition unit which determines whether or not the fingerprint image is a fingerprint image of the registered user.

7. A control method for an information processing apparatus including:
a chassis variable in form;
a system device; and
a sensor for acquiring biological information;
a user authentication unit which changes an operating mode of the system device from a power-saving mode to a standard mode consumed more power when a user to be registered is identified using the biological information as a pre-registered user, wherein the sensor is placed in the chassis, the control method executing
a step of causing the information processing apparatus to control supply of power to the user authentication unit based on the form.
